(19) United States
(12) Patent Application Publication
(10) Pub. No.: US 2015/0159237 A1
(43) Pub. Date: Jun. 11, 2015

(54) METHOD OF RECOVERING VALUES FROM ALUMINIUM DROSS

(71) Applicant: SALT EXTRACTION AB, VÄLLINGBY (SE)

(72) Inventors: Lidong Teng, Vasteras (SE); Mai Zhand, Beijing (CN); Seshadri Seetharaman, Taby (SE)

(21) Appl. No.: 14/403,621

(22) PCT Filed: May 27, 2013
(86) PCT No.: PCT/SE2013/050604

§ 371 Date: Nov. 25, 2014

(30) Foreign Application Priority Data
May 25, 2012 (SE) 1250535-0

(51) Int. Cl. C22B 7/00; C01C 1/26; C22B 21/00

(52) U.S. Cl. CPC C22B 7/006; C22B 21/0023; C01C 1/26

(57) ABSTRACT

The invention concerns a Method of recovering values from aluminum dross comprising the steps of: a1) dissolving the aluminum dross in water thereby forming a salt solution, NH₃ containing gas, and solid residues; b1) separating the NH₃ containing gas; and c1) reacting the NH₃ containing gas with CO₂ in CO₂ containing water saturated to at least 20% of maximum CO₂ saturation to form ammonium carbonate and/or ammonium bicarbonate. According to another embodiment, the method comprises the steps of: a2) dissolving the aluminum dross in CO₂ containing water saturated to at least 20% of maximum CO₂ saturation, thereby forming a salt solution, and solid residues; and b2) separating the solid residues from the salt solution.

### TECHNICAL FIELD

The invention relates to a method of recovering values from aluminum dross.

### BACKGROUND

Aluminum dross is a by-product from aluminum smelting. If the aluminum content in the dross is sufficiently high the dross can be melted to recover metallic aluminum. The residue from remelting the dross is sometime called a salt cake. In the present application the term aluminum dross also includes salt cakes from aluminum dross.

The common ingredients of aluminum dross are NaCl , KCl, Al₂O₃, AN, MgO, SiO₂ and entrapped metallic aluminum, which could be as high as 5 wt % or more. The dross contains some water-soluble compounds, which react with water or environmental humidity and release chlorides and/or generate toxic gases in particular NH₃. Depositing the dross or using them as landfill can therefore have a negative environmental impact. Aluminum and other metals present in the dross may also leach to the environment.

### OBJECT OF THE INVENTION

It is an object of the invention to reduce environmental impact from aluminum dross.

Another object of the invention is to recover values from aluminum dross.

### DESCRIPTION OF THE INVENTION

At least one of the objects is at least to some extent solved by the method as defined in the claims.

According to one embodiment of the invention the method comprises the steps of:
a1) dissolving the aluminum dross in water thereby forming a salt solution, NH₃ containing gas, and solid residues;
b1) separating the NH₃ containing gas; and
c1) reacting the NH₃ containing gas with CO₂ in CO₂ containing water saturated to at least 20% of maximum CO₂ saturation to form ammonium carbonate and/or ammonium bicarbonate.

By reacting the NH₃ containing gas in CO₂ containing water ammonium carbonate and/or ammonium bicarbonate is formed. The resulting aqueous solution will contain almost entirely the ammonium carbonates/bicarbonates, free of salt, and can be used as a fertilizer. Alternately, water can be evaporated to produce solid ammonium carbonate.

However, it is preferred to maintain it as liquid fertilizers since, as known in the art, liquid fertilizers have several advantages over solid fertilizers.

The remaining salt solution including solid residues is less harmful to the environment than the original aluminum dross, and can be further treated to further reduce its environmental impact as well as to recover additional values therefrom. Furthermore, the method can be used to capture CO₂ gas to reduce emissions of CO₂ to air from a CO₂ emitting source.

Preferably the method additionally includes the step:
d1) separating solid residues from the salt solution;

Thereby solid residues from the dross such as e.g. oxides of Al, Mg, Si and metallic aluminum can be handled separately. For instance the residues can be used to produce ceramic materials, preferably aluminum oxynitrides such as SiAlON, MgSiAlON. Nitrogen can be reinstated by heat treating the residues in a nitrogen atmosphere. The residues may also be reused as slag formers in melting metallurgy.

Preferably the method additionally includes the step:
e1) Evaporating water from the salt solution and reclaiming the salt components. Water is preferably evaporated after removing solid residues. After evaporation, salt components such as NaCl and KCl remain. Smaller amounts (typically less than 10% by weight) of CaF₂ may also be present depending on the composition of the dross. The recovered salt components can, for instance, be reused in aluminum smelting process

Preferably in step c1) the CO2 containing water is saturated to at least 40% of maximum CO₂ saturation, preferably at least 60%, more preferably at least 80%, most preferably fully saturated. Higher saturation of CO₂ facilitates the formation of ammonium carbonate and/or ammonium bicarbonate.

Preferably in step c1) the CO₂ is bubbled through the water to maintain sufficient levels of CO₂ saturation. Thereby the desired state facilitating formation of ammonium carbonate and/or ammonium bicarbonate is maintained.

The dross and contains nitrogen containing components, in particular AlN. AlN reacts with water through hydrolysis forming NH₄₊/NH₃.The dross may additionally contain components such as NaCl, KCl, Al, Al₂O₃, SiO₂, Si, CaF₂, MgO, Fe₂O₃, CaO. Typically Al₂O₃ is around 30-60 wt %, AlN 5-15 wt %, NaCl+KCl 20-50 wt %, MgO<10 wt %, Si+SiO₂<10 wt %, Fe₂O₃<5 wt %, Al<10 wt %, CaO<5 wt %. The dross may contain traces of AlP, Al₄C₃ and CaF₂. If AlP is present PH₃ gas may also evaporate and producing phosphate when reacting with H₂O and NH₃ that will add value to the fertilizer.

The temperature, when dissolving the dross in water is held above 80° C., preferably the water is boiling. Increasing temperatures facilitates the releasing of ammonia gas to gas phase. In CO₂-free boiling water ammonia gas will be released to gas phase almost completely. The ammonia gas is accompanied by steam emission as well.

Preferably in step a1) the solution is stirred during dissolving.

Preferably the duration of the dissolving step a1) is in the range of 0.5-10 hours, preferably 1-4 hours.

Preferably in step c1) the mole ratio between CO₂/NH₃ is controlled to be >0.53, preferably >0.6. Thereby formation of ammonium bicarbonate is facilitated.

Preferably in step c1) the temperature of the CO₂ containing water is held in the range of 10-50° C., preferably in the range of 15-30° C.

The water in step a1) may be deionized.

Preferably, in step a1) the solid-liquid ratio is in the range of 1:4 to 1:100, preferably in the range of 1:10 to 1:30.

Of course, the aluminum dross may be crushed and/or milled and/or ground before being dissolved in step a1).

According to another embodiment of the invention the method comprises the steps of:
a2) dissolving the aluminum dross in CO₂ containing water saturated to at least 20% of maximum CO₂ saturation, thereby forming a salt solution, and solid residues; and
b2) separating the solid residues from the salt solution.

The CO₂ saturation prevents hydrolysis of AlN and thereby formation of NH₃ gas. Additionally small amount of NH₃ produced can be effectively absorbed by the formation of NH₄HCO₃ species in the aqueous salt solution. Dissolving in CO₂-saturated water enables the selective dissolution removal of the chlorides by forming a salt solution without affecting AlN, which will remain in the solid residue. In other words, this is an alternative way of using CO₂-containing water to reduce the environmental impacts of aluminum dross and recover values therefrom. Both methods address the issue of NH₃. The solid residues may include oxides of Al, Mg, Si, AlN and metallic aluminum. The residues can be used to produce ceramic materials, preferably aluminum oxynitrides such as SiAlON, MgSiAlON, or they may also be reused as slag formers and/or as alloying additives in melting metallurgy.

Preferably the method additionally comprises the step:
c2) evaporating water from the salt solution and reclaiming the salt components;

Water is preferably evaporated after removing solid residues. After evaporating salt components such as NaCl and KCl remain. Smaller amounts (typically less than 10% by weight) of CaF₂ may also be present depending on the composition of the dross. The recovered salt components can for instance be reused in aluminum smelting process

Preferably the method additionally comprises the step:
d2) forming aluminum oxynitride from the solid residues, in particular silicon aluminum oxynitride or magnesium silicon aluminum oxynitride.

Preferably in step a2), the CO₂ containing water saturated to at least 40% of maximum CO₂ saturation, preferably at least 60%, more preferably at least 80%, most preferably fully saturated. Higher CO₂ saturation is better for preventing AlN to react with water as well as for capturing any formed NH₃.

Preferably in step a2), the CO₂ is bubbled through the water to maintain sufficient levels of CO₂ saturation. Thereby the CO₂ saturation can be maintained at desired levels.

Preferably, in step a2) the solid-liquid ratio is in the range of 1:4 to 1:100, preferably in the range of 1:10 to 1:30.

Preferably in step a2) the temperature of the CO₂ containing water is held in the range of 10-80° C., preferably in the range of 15-50° C.

Preferably in step a2) the solution is stirred during dissolving.

Preferably the duration of the dissolving step a2) is in the range of 0.5-10 hours, preferably 1-4 hours.

Of course, the aluminum dross may be crushed and/or milled and/or ground before being dissolved in step a2).

1. Method of recovering values from aluminum dross comprising the steps of:
a1) dissolving the aluminum dross in water thereby forming a salt solution, NH3 containing gas, and solid residues;
b1) separating the NH₃ containing gas; and
c1) reacting the NH₃ containing gas with CO₂ in CO₂ containing water saturated to at least 20% of maximum CO₂ saturation to form ammonium carbonate and/or ammonium bicarbonate.

2. The method according to claim 1 wherein the method additionally comprises one ore more of the following steps:
d1) separating solid residues from the salt solution;
e1) evaporating water from the salt solution and reclaiming the salt components, and;
f1) forming aluminum oxynitride from the solid residues such as silicon aluminum oxynitride ands/or magnesium silicon aluminum oxynitride.

3-16. (canceled)

17. The method according to claim 1, wherein in step c1) the CO₂ containing water is saturated to at least 40% of maximum CO₂ saturation.

18. The method according to claim 1, wherein in step c1) the CO₂ containing water is saturated to at least 60% of maximum CO₂ saturation.

19. The method according to claim 1, wherein in step c1) the CO₂ containing water is saturated to at least 80% of maximum CO₂ saturation.

20. The method according to claim 1, wherein in step c1) the CO₂ containing water is fully saturated.

21. The method according to claim 1, wherein in step c1) CO₂ is bubbled through the water to maintain sufficient levels of CO₂ saturation.

22. The method according to claim 1, wherein the dross contains at least one nitrogen containing component, in particular AlN.

23. The method according to claim 1, wherein the temperature in step al) when dissolving the dross in water is held above 80° C.

24. The method according to claim 1, wherein the temperature in step al) when dissolving the dross in water is boiling.

25. The method according to claim 1, wherein the in step c1) the mole ratio between CO₂/NH₃ is controlled to be >0.53, preferably >0.6.

26. The method according to claim 1, wherein the in step c1) the temperature of the CO₂ containing water is held in the range of 10-50° C., preferably in the range of 15-30° C.

27. The method according to claim 1, wherein in step a1) the solid-liquid ratio is in the range of 1:4 to 1:100, preferably in the range of 1:10 to 1:30.

28. Method of recovering values from aluminum dross comprising the steps of:
a2) dissolving the aluminum dross in CO₂ containing water saturated to at least 20 of maximum CO₂ saturation, thereby forming a salt solution, and solid residues; and
b2) separating the solid residues from the salt solution.

29. The method according to claim 28, wherein the method additionally comprises one ore more of the following steps:
c2) evaporating water from the salt solution and reclaiming the salt components;
d2) forming aluminum oxynitride from the solid residues.

30. The method according to claim 28, wherein the aluminum oxynitride is silicon aluminum oxynitride or magnesium silicon aluminum oxynitride.

31. The method according to claim 28, wherein the CO₂ containing water saturated to at least 40% of maximum CO₂ saturation, preferably at least 60%, more preferably at least 80%, most preferably fully saturated.

32. The method according to claim 28, wherein the CO₂ is bubbled through the water to maintain sufficient levels of CO₂ saturation.

33. The method according to claim 28, wherein in step a2) the temperature of the CO2 containing water is held in the range of 10-80° C., preferably in the range of 15-50° C.

34. The method according to claim 28, wherein in step a2) the solid-liquid ratio is in the range of 1:4 to 1:100, preferably in the range of 1:10 to 1:30.
